(19) United States
(12) Patent Application Publication
(10) Pub. No.: US 2013/0337806 A1
(43) Pub. Date: Dec. 19, 2013

(54) DEVICE, SYSTEM AND METHOD OF SCANNING WIRELESS COMMUNICATION CHANNELS

(71) Applicants: Yair Barash, Tivon (IL); Ahmad Masri, Nahif Village (IL); Oded Liron, Givaat-Ada (IL)

(72) Inventors: Yair Barash, Tivon (IL); Ahmad Masri, Nahif Village (IL); Oded Liron, Givaat-Ada (IL)

(21) Appl. No.: 13/526,558

(22) Filed: Jun. 19, 2012

(51) Int. Cl. H04W 24/00

(52) U.S. Cl. 455/434

(57) ABSTRACT

Some demonstrative embodiments include devices, systems and/or methods of scanning wireless communication channels. For example, a device may include a controller to receive one or more energy indications corresponding to one or more frequency ranges within a wireless communication frequency band, wherein a frequency range of the frequency ranges at least partially covers a plurality of wireless communication frequency channels, and wherein the controller is to scan for at least one wireless communication beacon over one or more channels of the plurality of wireless communication frequency channels, if an energy indication corresponding to the frequency range indicates wireless communication activity over the frequency range.

### BACKGROUND

A first wireless communication device may scan one or more wireless communication channels to detect a second wireless communication device. For example, a wireless communication station may scan a plurality of wireless communication channels to detect an Access Point (AP).

According to a first scanning method (“Active Scanning”), the station may actively broadcast probe packets over the plurality of wireless communication channels, and wait for an AP to reply. The active scanning method may compromise security, for example, in scenarios where the station is left “unattended”, e.g., when performing an offload operation, such as a “Net Detect” operation, during sleep mode, and a potential hacker may track the probe packets.

According to a second scanning method (“Passive Scanning”), the station may tune to a channel and wait to receive a packet over the channel. When performing the passive scanning method, the station is required to listen to each of the channels for a time period longer than required according to the active scanning method.

In some implementations, for example, according to the IEEE standards, e.g., IEEE 802.11-2007, IEEE Standard for Information Technology—Telecommunications and information exchange between systems—Local and metropolitan area networks—Specific requirements, Part 11: Wireless LAN Medium Access Control (MAC) and Physical Layer (PHY) Specifications, the station may listen to each channel for detecting a beacon packet from the AP. The AP may transmit the beacon packet at a predefined beacon interval, e.g., an interval of 100 milliseconds (ms). Accordingly, the station may listen to each channel for a time period equal to or greater than the beacon interval, to enable detection of the beacon, e.g., even in cases where the AP has postponed the transmission of the beacon, e.g., according to a contention mechanism.

A wireless communication frequency band may include a relatively large number of wireless communication channels. For example, the 2.4 Gigahertz (GHz) band may include 14 channels, and the 5.2 Gigahertz (GHz) band may include 24 channels, or any other number of channels, e.g., according to specific country regulations.

Accordingly, the station may be required to scan the wireless communication frequency band for a relatively long time period in order to detect existence of wireless communication activity, e.g., up to about 1.5 seconds for the 2.4 GHz frequency band, and up to about 3 seconds for the 5.2 GHz frequency band. As a result, the passive scanning of both the 2.4 GHZ and 5.2 GHz frequency bands may last for about 4.5 seconds.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of a plurality of frequency ranges, each defined to at least partially cover a plurality wireless communication frequency channels of a first frequency band, in accordance with some demonstrative embodiments.

FIG. 3 is a schematic illustration of two adjacent frequency ranges, each defined to cover a plurality wireless communication frequency channels of a second frequency band, in accordance with some demonstrative embodiments.

FIG. 4 is a schematic illustration of a method of scanning wireless communication channels, in accordance with some demonstrative embodiments.

FIG. 5 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), devices and/or networks operating in accordance with existing Wireless-Gigabit-Alliance (WGA) specifications (Wireless Gigabit Alliance, Inc WiGig MAC and PHY Specification Version 1.0, April 2010, Final specification) and/or future versions and/or derivatives thereof, devices and/or networks operating in accordance with existing IEEE 802.11 standards (IEEE 802.11-2007, IEEE Standard for Information Technology—Telecommunications and information exchange between systems—Local and metropolitan area networks—Specific requirements, Part 11: Wireless LAN Medium Access Control (MAC) and Physical Layer (PHY) Specifications; IEEE 802.11n-2009, IEEE Standard for Information Technology—Telecommunications and information exchange between systems—Local and metropolitan area networks—Specific requirements, Part 11: Wireless LAN Medium Access Control (MAC) and Physical Layer (PHY) specifications, Amendment 5: Enhancements for Higher Throughput; IEEE802.11 task group ac (TGac) (“IEEE802.11-09/0308r12—TGac Channel Model Addendum Document”), IEEE 802.11 task group ad (TGad)) (IEEE P802.11ad/D1.0 Draft Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 5: Enhancements for Very High Throughput in the 60 GHz Band), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing Wireless-WirelessHD™ specifications and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

Some demonstrative embodiments may be used in conjunction with a wireless communication network, e.g., a WLAN, communicating over a frequency band of up to 6 Gigahertz (GHz), for example, a frequency band of 2.4 GHz and/or a frequency band of 5.2 GHz. However, other embodiments may be implemented utilizing any other suitable wireless communication frequency bands, for example, an Extremely High Frequency (EHF) band (the millimeter wave (mmwave) frequency band), e.g., a 60 GHz frequency band, a frequency band within the frequency band of between 30 Ghz and 300 GHZ, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include at least one of a phased array antenna, a single element antenna, a set of switched beam antennas, and the like.

The term “station” (STA), as used herein, may include any logical entity that is a singly addressable instance of a medium access control (MAC) and a physical layer (PHY) interface to a wireless medium (WM).

The phrase “access point” (AP), as used herein, may include an entity that provides access to distribution services, via the WM for associated STAs.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

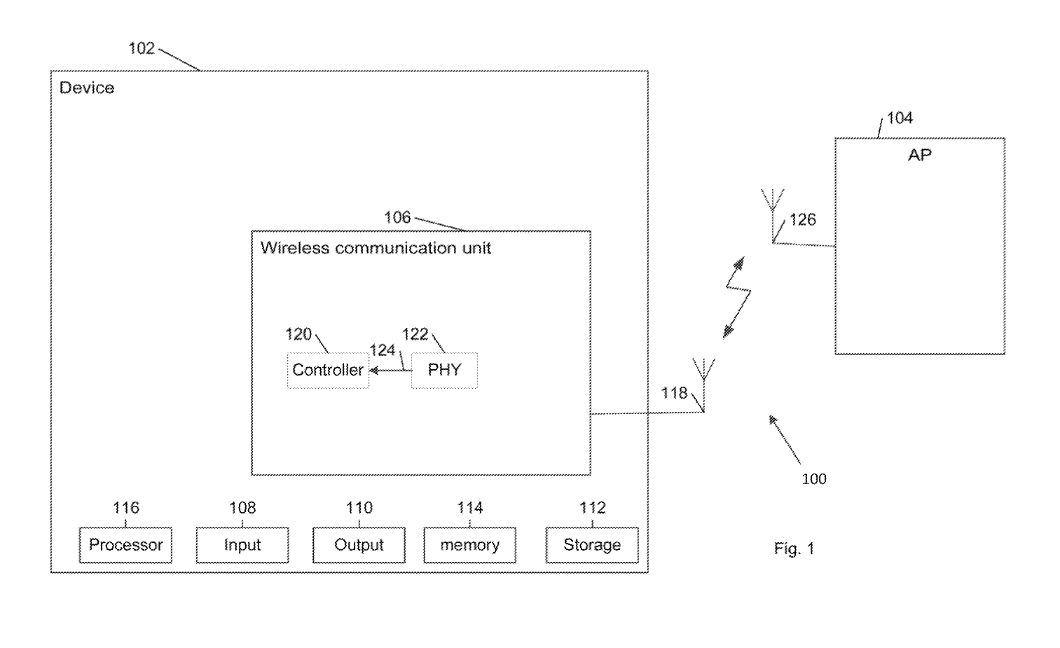

Reference is now made to FIG. 1, which schematically illustrates a block diagram of a system 100, in accordance with some demonstrative embodiments.

In some demonstrative embodiments, one or more elements of system 100 may be capable of communicating content, data, information and/or signals over one or more suitable wireless communication links, for example, a radio channel, an IR channel, a RF channel, a Wireless Fidelity (WiFi) channel, and the like. One or more elements of system 100 may optionally be capable of communicating over any suitable wired communication links.

As shown in FIG. 1, in some embodiments, system 100 may include at least one wireless communication device (“station”) 102, which includes a wireless communication unit 106 capable of performing wireless communication with one or more other devices of system 100, e.g., as described below.

In some demonstrative embodiments, wireless communication device 102 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, or the like.

In some demonstrative embodiments device 102 may include, for example, one or more of a processor 116, an input unit 108, an output unit 110, a memory unit 114, and a storage unit 112. Device 102 may optionally include other suitable hardware components and/or software components. In some embodiments, some or all of the components of device 102 may be enclosed in a common housing or packaging, and may be interconnected or operably associated using one or more wired or wireless links. In other embodiments, components of device 102 may be distributed among multiple or separate devices or locations.

Processor 116 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 116 executes instructions, for example, of an Operating System (OS) of device 102, and/or of one or more suitable applications.

Input unit 108 includes, for example, a keyboard, a keypad, a mouse, a touch-pad, a track-ball, a stylus, a microphone, or other suitable pointing device or input device. Output unit 110 includes, for example, a monitor, a screen, a flat panel display, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 112 includes, for example, a hard disk drive, a floppy disk drive, a Compact Disk (CD) drive, a CD-ROM drive, a DVD drive, or other suitable removable or non-removable storage units. Memory unit 114 and/or storage unit 112, for example, store data processed by device 102.

In some demonstrative embodiments, wireless communication unit 106 includes, for example, one or more wireless transmitters, receivers and/or transceivers able to send and/or receive wireless communication signals, RF signals, frames, blocks, transmission streams, packets, messages, data items, and/or data. For example, wireless communication unit 106 may include or may be implemented as part of a wireless Network Interface Card (NIC), and the like.

Wireless communication unit 106 may include, or may be associated with, one or more antennas or one or more sets of antennas 118. Antennas 118 may include, for example, an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data.

In some demonstrative embodiments, wireless communication unit 106 may be capable of communicating with an Access Point (AP) 104 over a wireless communication band, e.g., over the 2.4 GHz and/or the 5.2 GHz frequency bands (“the 2.4/5.2 Ghz frequency band”), or any other frequency band.

In some demonstrative embodiments, wireless communication unit 106 may scan the wireless communication frequency band, e.g., the 2.4/5.2 GHz frequency band, to detect AP 104, e.g., as described in detail below.

In some demonstrative embodiments, wireless communication unit 106 may include a controller 120, e.g., a Medium-Access-Controller (MAC), and a Physical layer (PHY) 122 configured to communicate signals over the wireless communication medium.

In some demonstrative embodiments, PHY 122 may be capable of communicating signals over a relatively wide frequency range, e.g., a frequency range greater than a width of a frequency channel.

In some demonstrative embodiments, PHY 122 may be capable of communicating signals over a frequency range, which at least partially covers two or more wireless communication frequency channels.

In some demonstrative embodiments, PHY 122 may be capable of communicating signals over a frequency range including an extended frequency channel, which includes a primary (“control”) channel, e.g., a 20 MHz channel, and one or more secondary (“extension”) channels.

In one example, the extended frequency channel may include an extended frequency channel in the 2.4 GHz frequency band. For example, the extended frequency channel may have a bandwidth of 40 MHz, and may include a 20 MHz primary channel and a 20 MHz secondary channel.

In another example, the extended frequency channel may include an extended frequency channel in the 5.2 GHz frequency band.

In one example, the extended frequency channel may include a 20 MHz channel including a 20 MHZ primary channel. In another example, the extended frequency channel may include a 40 MHz extended channel including a 20 MHZ primary channel and a 20 MHz secondary channel. In yet another example, the extended frequency channel may include an 80 MHz extended channel including a 20 MHZ primary channel, a 20 MHz secondary channel and a 40 MHz secondary channel. In yet another example, the extended frequency channel may include a 160 MHz extended channel including a 20 MHZ primary channel, a 20 MHz secondary channel (“secondary-1”), a 40 MHz secondary channel (“secondary-2”) and an 80 MHz secondary channel (“secondary-3”). The extended frequency channel may include any other frequency channel, having any other bandwidth and/or including any other combination of primary and secondary channels.

In some demonstrative embodiments, wireless communication unit 106 may utilize the secondary channels in conjunction with the primary channel in order to communicate, e.g., at an extended throughput.

In some demonstrative embodiments, wireless communication unit 106 may be capable of fully handling and/or processing wireless communication packets communicated only over the primary channel. Wireless communication unit 106 may be capable, for example, of fully handling and/or processing wireless communication packets simultaneously communicated over both the primary channel and one or more of the secondary channels. Wireless communication unit 106 may not be capable of fully handling and/or processing wireless communication packets communicated only over one or more of the secondary channels. For example, wireless communication unit 106 may be capable of processing, e.g., parsing, analyzing and/or decoding, a 20 MHz frame received over the primary channel and/or a 40 MHz frame simultaneously received over a 20 MHz primary channel and a 20 MHz secondary channel. When a 20 MHz frame is communicated only over the secondary channel, wireless communication unit 106 may only be capable of, for example, detecting wireless communication activity over the secondary channel.

In some demonstrative embodiments, wireless communication unit 106 may be capable of analyzing the wireless communication activity over one or more of the secondary channels, for example, to identify one or more 20 MHz channels, which may include wireless communication activity. For example, if wireless communication unit 106 detects wireless communication over the 40 MHz secondary-2 channel, wireless communication unit 106 may be able to determine, which one or both of the two 20 MHz channels covered by the 40 MHz secondary channel includes the wireless communication activity. For example, wireless communication unit 106 may utilize one or more band pass filters corresponding to the secondary channels.

In some demonstrative embodiments, PHY 122 may be capable of generating one or more energy indications 124 corresponding to the frequency range to which PHY 122 is tuned. Energy indications 124 may indicate, for example, whether or not wireless communication activity is detected over the frequency range. In one example, energy indications 124 may include a clear channel assessment (CCA) indication, or any other indication.

In some demonstrative embodiments, wireless communication unit 106 may scan a predefined frequency band, e.g., the 2.4/5.2 GHz frequency band, to detect AP 104. Although some demonstrative embodiments are described herein with reference to detecting an AP, e.g., AP 104, other embodiments may be implemented to detect any other wireless communication device. For example, wireless communication unit 106 may scan the predefined frequency band to detect a Personal Area Network (PAN) device, e.g., a group owner (GO), or any other WIFi transmitter.

In some demonstrative embodiments, wireless communication unit 106 may passively scan the frequency band by attempting to detect a packet, e.g., a beacon packet, from AP 104. For example, according to the IEEE standards, e.g., IEEE 802.11-2007, AP 104 may transmit a beacon packet at a predefined beacon interval, e.g., an interval of 100 milliseconds (ms).

In some demonstrative embodiments, wireless communication unit 106 may utilize PHY 122 to simultaneously examine a plurality of wireless communication channels of the frequency band for detecting the beacon packet from AP 104.

In some demonstrative embodiments, wireless communication unit 106 may perform a preliminary sweep of one or more frequency channels, each frequency range including a plurality of wireless communication channels, based on an energy indication corresponding to the frequency range. Based on the preliminary sweep, wireless communication unit 106 may selectively select one or more of the frequency channels to be scanned, e.g., while selectively skipping the scanning of one or more, e.g., non-selected, frequency channels, as described below.

In some demonstrative embodiments, controller 120 may control PHY 122 to sequentially tune to a plurality of frequency ranges, e.g., by controlling PHY 122 to tune to a first frequency range for a predefined period of time, e.g., a equal to or greater than the beacon interval of AP 104, to switch to tune to a second frequency range for the predefined period of time, and so on, e.g., as described below.

In some demonstrative embodiments, the frequency range may include the extended frequency channel configured for PHY 122, and controller 120 may control PHY 122 to tune to the extended frequency channel. For example, the extended frequency channel may include a frequency range of 40 MHz, 80 MHz, or 160 MHz, e.g., as described above.

In some demonstrative embodiments, controller 120 may utilize the extended frequency channel to perform a passive pseudo scan of the frequency channels covered, at least partially, by the extended frequency channel. For example, PHY 122 may generate energy indications 124 indicating whether or not wireless communication activity is detected, e.g., over the entire extended frequency channel, to which PHY 122 is being tuned.

In some demonstrative embodiments, controller 120 may be configured to determine whether or not to scan one or more frequency channels covered the frequency range to which PHY 122 is tuned, and/or whether to skip scanning one or more other frequency channels of the frequency range, based on the energy indication 124 corresponding to the frequency range, e.g., as described below.

In some demonstrative embodiments, controller 120 may be capable of determining whether or not to scan the one or more frequency channels covered by the frequency range to which PHY 122 is tuned, for example, even if controller 120 is not able to receive actual packets over the entire frequency range, e.g., as described above.

In some demonstrative embodiments, controller 120 may control PHY 120 to sequentially tune to listen to a plurality of frequency ranges within a wireless communication frequency band, in which AP 104 is to be detected. A frequency range of the frequency ranges may be defined to at least partially cover a plurality of wireless communication frequency channels of the wireless communication frequency band.

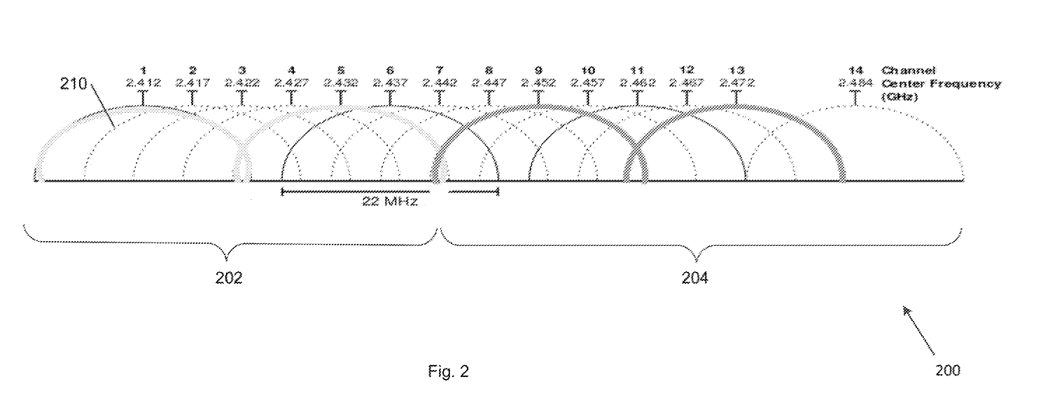

In one example, the wireless communication frequency band may include the 2.4 GHz frequency band, and the plurality of frequency ranges may include two 40 MHz frequency ranges, e.g., at least partially covering a plurality of 20 MHz frequency channels of the 2.4 GHz frequency band, for example, as described below with reference to FIG. 2.

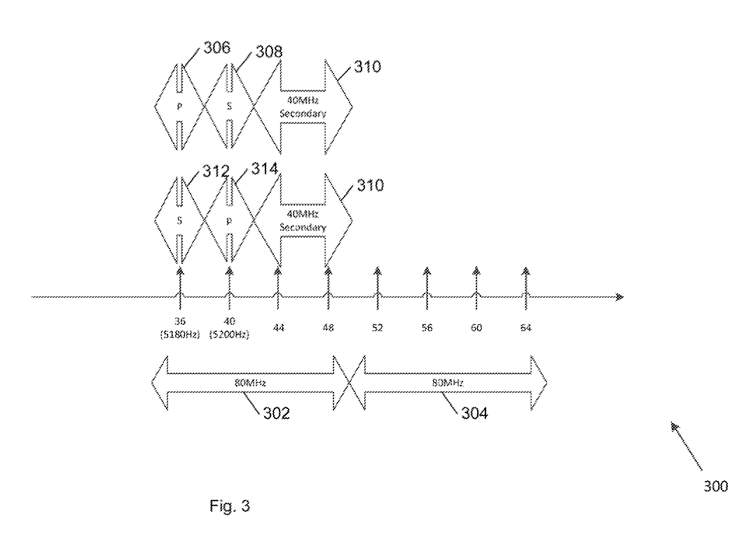

In another example, the wireless communication frequency band may include the 5.2 GHz frequency band, and the plurality of frequency ranges may include a plurality of 40 MHz, 80 MHz and/or 160 MHz frequency ranges, e.g., at least partially covering a plurality of 20 MHz frequency channels of the 5.2 GHz frequency band, for example, as described below with reference to FIG. 3.

In some demonstrative embodiments, at least one frequency range of the frequency ranges may be defined to include an extended frequency channel including a primary channel and one or more secondary channels.

In one example, the frequency range may include a 40 MHz extended frequency channel including a primary 20 MHz frequency channel and a secondary 20 MHz frequency channel, e.g., if the wireless communication band includes the 2.4 GHz frequency band or the 5.2 GHz frequency band.

In another example, e.g., in the 5.2 GHz band, the frequency range may include an 80 MHz extended frequency channel including a primary 20 MHz frequency channel a secondary-1 20 MHz channel and secondary-2 40 MHz channel. In yet another example, e.g., in the 5.2 GHz band, the frequency range may include a 160 MHz extended frequency channel including a primary 20 MHz frequency channel, a secondary-1 20 MHz channel, a 40 MHz secondary-2 channel and a secondary-3 80 MHz channel. In other embodiments, the frequency range may include any other extended frequency channel including any suitable combination of a primary frequency channel and one or more secondary frequency channels.

In some demonstrative embodiments, controller 120 may control PHY 122 to tune to a frequency range (“the current frequency range”) of the frequency ranges for a predefined time period (“the current tuning period”), which may be set, for example, to be equal to or greater than a typical or minimal beacon interval to be utilized by AP 104. For example, controller 120 may control PHY to tune to tune to each of the frequency ranges for at least 100 milliseconds (ms), e.g., at least 110 ms, for example, if AP 104 is assumed to utilize a beacon interval of 100 ms, e.g., to enable detection of the beacon even in cases where AP 104 has postponed the transmission of the beacon, e.g., according to a contention mechanism.

In some demonstrative embodiments, controller 120 may receive from PHY 122 the energy indication 124 indicting whether or not wireless communication energy is detected over the current frequency range during the current tuning period.

In some demonstrative embodiments, controller 120 may select whether to scan one or more frequency ranges covered by the current frequency range or whether to skip scanning one or more other frequency ranges covered by the current frequency range, based on the energy indication 124 corresponding to the current frequency range.

In some demonstrative embodiments, controller 120 may select to scan, e.g., to passively scan, for at least one wireless communication beacon from AP 104 over one or more frequency channels of the plurality of wireless communication frequency channels of the current frequency range, e.g., if the energy indication 124 corresponding to the current frequency range indicates that wireless communication activity is detected over the current frequency range.

In some demonstrative embodiments, the current frequency range may include an extended frequency channel (“the current extended frequency channel”). Accordingly, controller 120 may be capable of fully handling and/or processing wireless communication packets communicated over the primary channel of the current extended frequency channel during the current tuning period in which PHY 122 is tuned to the current extended frequency channel. Therefore, controller 120 may be capable of detecting a beacon packet from AP 104, if the beacon packet is transmitted by AP 104 during the current tuning period. Accordingly, controller 120 may not be required to perform a separate passive scanning of the primary channel of the current extended frequency channel, e.g., regardless of whether or not energy indication 124 indicates wireless communication activity over the current extended frequency channel.

According to these demonstrative embodiments, controller 120 may select to scan one or more of the secondary channels of the current extended frequency channel, and not the primary channel of the current extended frequency channel, if the energy indication 124 corresponding to the current frequency range indicates wireless communication activity over the current frequency range.

In some demonstrative embodiments, controller 120 may select to skip scanning all of the plurality of wireless communication frequency channels of the current frequency range, for example, if the energy indication 124 corresponding to the current frequency range does not indicate wireless communication activity over the current frequency range.

In some demonstrative embodiments, controller 120 may select to scan all of the plurality of wireless communication frequency channels of the current frequency range, for example, if the energy indication 124 corresponding to the current frequency range indicates wireless communication activity over the current frequency range.

In other demonstrative embodiments, controller 120 may select to scan only one or more channels of the current frequency range, and not to scan one or more other channels of the current frequency range.

For example, PHY 122 may be configured to generate the energy indication 124 corresponding to the current frequency range in the form of an indication, which is configured to indicate to controller 120 one or more particular frequency channels of the current frequency range, in which wireless communication activity is detected. Controller may select to scan only the one or more particular frequency channels indicated by energy indication 124, and not to scan one or more other channels of the current frequency range.

In some demonstrative embodiments, controller 120 may select whether or not to scan one or more frequency channels of the current frequency range based, for example, on a relation between a duration of the wireless communication activity over the current frequency range and a predefined wireless communication packet duration.

For example, controller 120 may compare the duration of the wireless communication activity over the current frequency range, as indicated by energy indication 124, with the predefined wireless communication packet duration. The predefined wireless communication packet duration may include, for example, a minimal duration of a WLAN packet, e.g., as defined by the IEEE 802.11 specification, an assumed minimal or typical beacon duration of a beacon packet.

In some demonstrative embodiments, controller 120 may select to scan one or more frequency channels of the current frequency range, for example, if the duration of the wireless communication activity detected over the current frequency range is equal to or greater than the predefined wireless communication packet duration.

In some demonstrative embodiments, controller 120 may select to skip scanning all of the frequency channels of the current frequency range, for example, if the duration of the wireless communication activity over the current frequency range is lesser than the predefined wireless communication packet duration.

In some demonstrative embodiments, selectively scanning the wireless communication channels of the wireless communication frequency band based on energy indications 124, e.g., as described herein, may enable reducing a scanning period, during which controller 120 is to passively scan to detect AP 104.

Accordingly, selectively scanning the wireless communication channels of the wireless communication frequency band based on energy indications 124 may reduce a power consumption of device 102 during the scanning period.

For example, selectively scanning the wireless communication channels of the wireless communication frequency band based on energy indications 124 may be highly effective, e.g., in terms of power consumption, for example, in scenarios where wireless communication unit 106 is one of the main power consumers of device 102, e.g., including scenarios like wake-on-wireless LAN (WoWLAN) and/or Net Detect, where device 102 may be in a deep sleep mode and wireless communication unit 106 may be required to periodically scan for AP 104.

Reference is made to FIG. 2, which schematically illustrates frequency ranges 202 and 204, each defined to at least partially cover a plurality wireless communication frequency channels of a frequency band 200, in accordance with some demonstrative embodiments.

As shown in FIG. 2, frequency band 200 may include the 2.4 GHz frequency band, which includes 14 predefined 20 MHz wireless communication frequency channels 210, denoted “1” . . . “14”, e.g., defined by the central frequencies of 2.412 GHz, 2.417 GHz, 2.422 GHz, 2.427 GHz, 2.432 GHz, 2.437 GHz, 2.442 GHz, 2.447 GHz, 2.452 GHz, 2.457 GHz, 2.462 GHz, 2.467 GHz, 2.472 GHz, and 2.484 GHz.

As shown in FIG. 2, frequency range 202 may include an extended frequency channel of 40 MHz, having a central frequency of 2.422 GHz, and including a 20 MHz primary channel, e.g., channel “1”, and a 20 MHz secondary channel, e.g., the channel “5”.

As shown in FIG. 2, frequency range 202 may at least partially cover the channels “1”, “2”, “3”, “4”, “5”, “6”, “7”, “8” and “9”.

As shown in FIG. 2, frequency range 204 may include an extended frequency channel of 40 MHz, having a central frequency of 2.462 GHz, and including a 20 MHz primary channel, e.g., channel “9”, and a 20 MHz secondary channel, e.g., the channel “13”.

As shown in FIG. 2, frequency range 202 may at least partially cover the channels “6”, “7”, “8”, “9”, “10”, “11”, “12”, “13” and “14”.

In some demonstrative embodiments, PHY 122 (FIG. 1) may be capable of tuning to a 40 MHz channel, and controller 120 (FIG. 1) may perform a passive pseudo scan of the channels “1” through “14”, for example, by controlling PHY 122 (FIG. 1) to tune to frequency range 202, e.g., for a tuning period of at least 110 ms, and controlling PHY 122 (FIG. 1) to tune to frequency range 204, e.g., for a tuning period of at least 110 ms.

In some demonstrative embodiments, controller 120 (FIG. 1) may select whether or not to passively scan one or more of the channels covered by frequency range 202 based on the energy indication 124 (FIG. 1) corresponding to the frequency range 202, and/or whether or not to passively scan one or more of the channels covered by frequency range 204 based on the energy indication 124 (FIG. 1) corresponding to the frequency range 204, e.g., as described above.

For example, controller 120 (FIG. 1) may select to passively scan one or more of the channels covered by frequency range 202, e.g., excluding the primary channel “1”, if, for example, the energy indication 124 (FIG. 1) corresponding to the frequency range 202 indicates wireless communication activity. Controller 120 (FIG. 1) may select to skip scanning all of the channels covered by frequency range 202 if, for example, the energy indication 124 (FIG. 1) corresponding to the frequency range 202 does not indicate wireless communication activity.

For example, controller 120 (FIG. 1) may select to passively scan one or more of the channels covered by frequency range 204, e.g., excluding the primary channel “9”, if, for example, the energy indication 124 (FIG. 1) corresponding to the frequency range 204 indicates wireless communication activity. Controller 120 (FIG. 1) may select to skip scanning all of the channels covered by frequency range 204 if, for example, the energy indication 124 (FIG. 1) corresponding to the frequency range 204 does not indicate wireless communication activity.

In some demonstrative embodiments, selectively scanning the wireless communication channels of frequency band 200 by scanning frequency ranges 202 and 204, e.g., as described above, may enable reducing a scanning period, during which controller 120 (FIG. 1) is to passively scan to detect AP 104 (FIG. 1).

Accordingly, selectively scanning the wireless communication channels of the wireless communication frequency band by scanning frequency ranges 202 and 204 may reduce a power consumption of device 102 (FIG. 1) during the scanning period.

For example, the selective scanning may be highly effective, e.g., in terms of power consumption, for example, in scenarios where wireless communication unit 106 (FIG. 1) is one of the main power consumers of device 102 (FIG. 1), e.g., including scenarios like WoWLAN and/or Net Detect, where device 102 (FIG. 1) may be in a deep sleep mode and wireless communication unit 106 (FIG. 1) may be required to periodically scan for AP 104 (FIG. 1).

In one example, scanning frequency band 200 by performing only two scans over ranges 202 and 204, to determine whether or not further scanning may be required, may replace performing thirteen scans over channels “1” . . . “13” 210 of band 200, e.g., if no wireless communication activity is detected over frequency ranges 202 and 204. Accordingly, a reduction of up to about 84% in the power consumption of device 102 (FIG. 1) may be achieved, e.g., if wireless communication activity is not detected over frequency ranges 202 and 204, thereby enabling controller 120 (FIG. 1) to entirely skip the passive scanning over frequency band 200.

In some demonstrative embodiments, scanning the frequency ranges 202 and 204 by tuning PHY 122 (FIG. 1) to the extended frequency range may result in a reduction in performance over one or more of the channels covered by the extended frequency range, e.g., a reduction of about 3 db. One or more of the frequency channels may suffer a greater reduction, for example, channels “1” and “9” may be partially covered by range 202 and, accordingly, may suffer a reduction of about 6 db.

In other embodiments, any frequency ranges and/or extended frequency channels, e.g., different from ranges 202 and 204, may be defined with respect to frequency band 200.

In one example, one or more selected frequency channels, e.g., the frequency channels “1”, “6” and “11”, may be commonly used for communication. Accordingly, the frequency ranges may be defined to enable a more efficient scanning of the selected frequency channels.

For example, a first frequency range may be defined to include a 40 MHz extended channel having a center frequency on channel “3” and a primary channel on channel “1”, and a second frequency range may be defined to include a 40 MHz extended channel having a center frequency on channel “9” and a primary channel on channel “11”.

According to this example, controller 120 (FIG. 1) may control PHY 122 (FIG. 1) to tune to the first frequency range for a first tuning period of at least 110 ms, and to tune to the second frequency range for a second tuning period of at least 110 ms.

Since the first frequency range includes channel “1” as the primary channel, controller 120 (FIG. 1) may be capable of detecting AP 104 (FIG. 1) over channel “1” during the first tuning period. Since the second frequency range includes channel “11” as the primary channel, controller 120 (FIG. 1) may be capable of detecting AP 104 (FIG. 1) over channel “11” during the second tuning period. Controller 120 (FIG. 1) may be capable of detecting AP 104 (FIG. 1) over channel “6”, which may be covered by the secondary channel of both the first and second frequency ranges, for example, if energy indication 124 (FIG. 1) indicate wireless communication activity during both the first and second tuning periods. Therefore, controller 120 (FIG. 1) may be capable of detecting AP 104 (FIG. 1) over channels “1”, “6”, and “11” based, for example, only on the first and second tuning periods, e.g., without performing any further scanning.

Reference is made to FIG. 3, which schematically illustrates of frequency ranges 302 and 304, each defined to cover a plurality wireless communication frequency channels of a second frequency band 300, in accordance with some demonstrative embodiments.

Frequency band 300 may include for example, a 5.2 GHz frequency band including a plurality of channels, e.g., including eight 20 MHz channels denoted “36”, “40”, “44”, “48”, “52”, “56”, “60” and “64”, as shown in FIG. 3.

In some demonstrative embodiments, a frequency range of range 302 and 304 may include an 80 MHz extended channel including a 40 MHz primary channel and a 40 Mhz secondary channel. The 40 MHz primary channel may include a 20 MHz primary channel and a 20 MHz secondary channel.

In one example, range 302 may include a 40 MHz secondary channel 310, e.g., covering channels “44” and “48”, and a 40 MHz primary channel including a 20 MHz primary (P) channel 306, e.g., covering channel “36”, and a 20 MHz secondary (S) channel 308, e.g., covering channel “38”.

In another example, range 302 may include the 40 MHz secondary channel 310, e.g., covering channels “44” and “48”, and a 40 MHz primary channel including a 20 MHz primary (P) channel 314, e.g., covering channel “38”, and a 20 MHz secondary (S) channel 312, e.g., covering channel “36”.

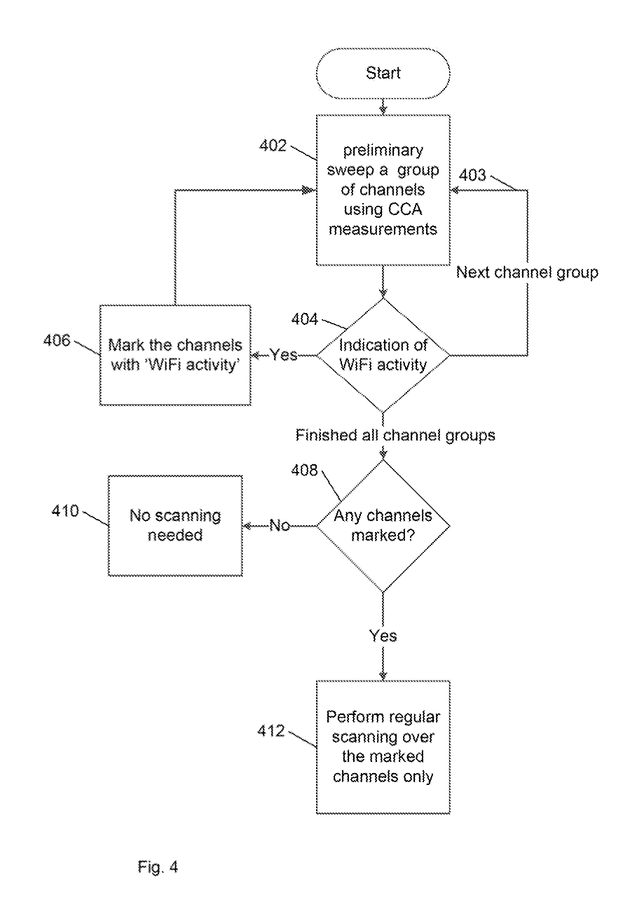

Reference is made to FIG. 4, which schematically illustrates a method of scanning wireless communication channels, in accordance with some demonstrative embodiments. In some embodiments, one or more of the operations of the method of FIG. 4 may be performed by any suitable wireless communication system e.g., system 100 (FIG. 1); wireless communication device, e.g., devices 102 and/or 130 (FIG. 1); and/or wireless communication unit, e.g., wireless communication units 104 and/or 132 (FIG. 1).

As indicated at block 402, the method may include performing a preliminary sweep of a group of wireless communication channels of a wireless communication frequency band. For example, controller 120 (FIG. 1) may control PHY 122 (FIG. 1) to measure an energy over a frequency range covering the group of wireless communication channels, for example, during the predefined tuning period, e.g., as described above. For example, PHY 122 (FIG. 1) may provide to controller 120 (FIG. 1) an energy indicator 124 (FIG. 1) corresponding to the frequency range, e.g., as described above.

As indicated at block 404, the method may include determining whether there is wireless communication activity over the group of wireless communication channels. For example, controller 120 (FIG. 1) may determine whether there is wireless communication activity over the group of wireless communication channels, based on the energy indicator 124 (FIG. 1) corresponding to the frequency range, e.g., as described above.

As indicated by arrow 403, the method may including switching to perform a preliminary sweep of another group of wireless communication channels of the wireless communication frequency band, e.g., if wireless communication activity is not detected over the group of wireless communication channels. For example, controller 120 (FIG. 1) may control PHY 122 (FIG. 1) to switch to measure an energy over another, e.g., subsequent, frequency range covering the other group of wireless communication channels, for example, during the predefined tuning period, e.g., as described above.

As indicated at block 406, the method may include marking the group of wireless communication channels, e.g., if wireless communication activity is detected over the group of wireless communication channels. For example, controller 120 (FIG. 1) may maintain information indicating that one or more channels of the group of wireless communication channels are marked for scanning, e.g., if the energy indicator 124 (FIG. 1) corresponding to the frequency range indicates wireless communication activity, e.g., as described above.

As indicated at block 408, the method may include determining whether one or more channels were marked for scanning, e.g., after performing the preliminary sweep with respect to all groups of wireless communication channels.

As indicated at block 410, the method may include skipping the passive scanning of all wireless communication channels of the wireless communication frequency band, e.g., if no channels were marked for scanning based on the preliminary sweeping. For example, controller 120 (FIG. 1) may skip a scanning operation for passively scanning the 2.4/5.2 GHz frequency bands, e.g., if indications 124 (FIG. 1) did not indicate any wireless communication activity over the 2.4/5.2 GHz frequency bands.

As indicated at block 412, the method may include passively scanning wireless communication channels marked for scanning For example, controller 120 (FIG. 1) may selectively passively scan the wireless communication channels marked for scanning, e.g., while skipping other wireless communication channels.

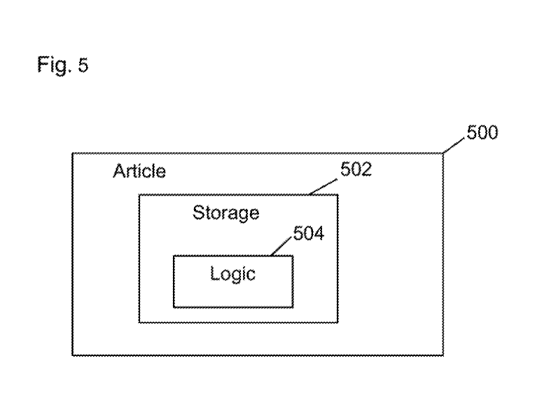

Reference is made to FIG. 5, which schematically illustrates an article of manufacture 500, in accordance with some demonstrative embodiments. Article 500 may include a non-transitory machine-readable storage medium 502 to store logic 504, which may be used, for example, to perform at least part of the functionality of wireless communication unit 106 (FIG. 1) and/or controller 120 (FIG. 1) and/or to perform one or more operations of the method of FIG. 4. The phrase “non-transitory machine-readable medium” is directed to include all computer-readable media, with the sole exception being a transitory propagating signal.

In some demonstrative embodiments, article 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a controller to receive one or more energy indications corresponding to one or more frequency ranges within a wireless communication frequency band, wherein a frequency range of said frequency ranges at least partially covers a plurality of wireless communication frequency channels, and wherein said controller is to scan for at least one wireless communication beacon over one or more channels of said plurality of wireless communication frequency channels, if an energy indication corresponding to the frequency range indicates wireless communication activity over said frequency range.

2. The apparatus of claim 1, wherein said frequency range comprises an extended frequency channel including a primary channel and one or more secondary channels.

3. The apparatus of claim 2, wherein said controller is to scan one or more of said secondary channels, and not said primary channel, if the energy indication corresponding to the frequency range indicates wireless communication activity over said frequency range.

4. The apparatus of claim 1, wherein said controller is to skip scanning all of said plurality of wireless communication frequency channels of said frequency range, if the energy indication corresponding to the frequency range does not indicate wireless communication activity over said frequency range.

5. The apparatus of claim 1, wherein said controller is to scan all of said plurality of wireless communication frequency channels of said frequency range, if the energy indication corresponding to the frequency range indicates wireless communication activity over said frequency range.

6. The apparatus of claim 1, wherein the controller is to select whether or not to scan the one or more channels of said frequency range, based on a relation between a duration of the wireless communication activity over said frequency range and a predefined wireless communication packet duration.

7. The apparatus of claim 1, wherein the energy indication corresponding to the frequency range comprises an indication of wireless communication activity in one or more particular channels of said plurality of wireless communication frequency channels, and wherein said controller is to scan said particular channels.

8. The apparatus of claim 1, wherein the energy indication relates to a measured energy over said frequency range during at least a predefined beacon interval.

9. The apparatus of claim 1, wherein said energy indication comprises a clear channel assessment (CCA).

10. The apparatus of claim 1, wherein said wireless communication frequency band comprises 2.5 Gigahertz (GHz) or a 5 GHz band.

11. A method comprising:
listening to a plurality of frequency ranges within a wireless communication frequency band, wherein a frequency range of said frequency ranges at least partially covers a plurality of wireless communication frequency channels; and
if wireless communication activity is detected over said frequency range, scanning one or more channels of said plurality of wireless communication frequency channels of said frequency range for at least one wireless communication beacon.

12. The method of claim 11, wherein listening to said plurality of frequency ranges comprises measuring an energy over said frequency range during at least a predefined beacon interval.

13. The method of claim 12, wherein measuring said energy comprises using a clear channel assessment (CCA) measurement.

14. The method of claim 11, wherein said frequency range comprises an extended frequency channel including a primary channel and one or more secondary channels.

15. The method of claim 14, wherein scanning the one or more channels of said frequency range comprises scanning one or more of said secondary channels, and not scanning said primary channel.

16. The method of claim 11 comprising skipping scanning of all of said plurality of wireless communication frequency channels of said frequency range, if wireless communication activity is not detected over said frequency range.

17. The method of claim 11, wherein said scanning comprises scanning all of said plurality of wireless communication frequency channels of said frequency range, if wireless communication activity is detected over said frequency range.

18. The method of claim 11 comprising selecting whether or not to scan the one or more channels of said frequency range, based on a relation between a duration of the wireless communication activity over said frequency range and a predefined wireless communication packet duration.

19. The method of claim 11 comprising detecting wireless communication activity in one or more particular channels of said plurality of wireless communication frequency channels of said frequency range, and scanning only said particular channels of said frequency range.

20. The method of claim 11, wherein scanning the one or more channels comprises passively scanning the one or more channels.

21. A system comprising:
at least one wireless communication device to scan a wireless communication frequency band for one or more beacons, said wireless communication device comprising:
a physical layer (PHY) to measure an energy over one or more frequency ranges within said wireless communication frequency band, wherein a frequency range of said frequency ranges at least partially covers a plurality of wireless communication frequency channels; and
a medium access controller (MAC) to scan for said beacons over one or more channels of said plurality of wireless communication frequency channels, if the energy over the frequency range indicates wireless communication activity over said frequency range.

22. The system of claim 21, wherein said frequency range comprises an extended frequency channel including a primary channel and one or more secondary channels, and wherein said MAC is scan only all of said secondary channels, and not said primary channel, if the energy indication corresponding to the frequency range indicates wireless communication activity over said frequency range.

23. The system of claim 21, wherein said MAC is to skip scanning all of said plurality of wireless communication frequency channels of said frequency range, if the energy indication corresponding to the frequency range does not indicate wireless communication activity over said frequency range.

24. The system of claim 21, wherein the MAC is to select whether or not to scan the one or more channels of the frequency range, based on a relation between a duration of the wireless communication activity over said frequency range and a predefined wireless communication packet duration.

25. The system of claim 21, wherein the PHY is to measure the energy indication over said frequency range during at least a predefined beacon interval corresponding to said beacons.

26. The system of claim 21, wherein said wireless communication device comprises one or more antennas to communicate signals over said wireless communication frequency band, a processor and a memory.

27. A non-transitory product including a storage medium having stored thereon instructions that, when executed by a machine, result in:
receiving one or more energy indications corresponding to one or more frequency ranges within a wireless communication frequency band, wherein a frequency range of said frequency ranges at least partially covers a plurality of wireless communication frequency channels; and
scanning for at least one wireless communication beacon over one or more channels of said plurality of wireless communication frequency channels if an energy indication corresponding to the frequency range indicates wireless communication activity over said frequency range.

28. The product of claim 27, wherein said frequency range comprises an extended frequency channel including a primary channel and one or more secondary channels, and wherein scanning the one or more channels of said frequency range comprises scanning one or more of said secondary channels, and not scanning said primary channel.

29. The product of claim 27, wherein said instructions result in skipping scanning of all of said plurality of wireless communication frequency channels of said frequency range, if wireless communication activity is not detected over said frequency range.
